(19) United States
(12) Patent Application Publication
(10) Pub. No.: US 2024/0302306 A1
(43) Pub. Date: Sep. 12, 2024

(54) ELECTRON PARAMAGNETIC RESONANCE (EPR) METHOD FOR EVALUATING THE PHOTOCATALYTIC ACTIVITY OF A PHOTOCATALYTIC SUBSTANCE

(71) Applicant: KING FAHD UNIVERSITY OF PETROLEUM AND MINERALS, Dhahran (SA)

(72) Inventors: Muhammad KAMRAN, Dhahran (SA); Mohamed Aly Mohamed MORSY, Dhahran (SA); Tarek Abdelsamad Abdelrahman KANDIEL, Dhahran (SA); Wissam IALI, Dhahran (SA)

(73) Assignee: KING FAHD UNIVERSITY OF PETROLEUM AND MINERALS, Dhahran (SA)

(21) Appl. No.: 18/179,054

(22) Filed: Mar. 6, 2023

(51) Int. Cl. G01N 24/10

(52) U.S. Cl. CPC G01N 24/10

(57) ABSTRACT

A method for monitoring and evaluating the photocatalytic activity of a photocatalytic substance is described. The method includes dispersing particles of the photocatalytic substance in a 4-hydroxy-2,2,6,6-tetramethylpiperidine-N-oxyl (TEMPOL) solution to form a photocatalytic suspension; introducing a gas composition to a reactor containing the photocatalytic suspension in the dark to form a purged photocatalytic suspension; illuminating the purged photocatalytic suspension with a light to initiate a photocatalytic reaction and generate a reactive oxygen species (ROS) that is detectable by an electron paramagnetic resonance (EPR) spectrometer; introducing a portion of the purged photocatalytic suspension to the EPR cell in the cavity of the EPR spectrometer to generate an EPR signal and recirculating the portion of the purged photocatalytic suspension back to the reactor; reacting TEMPOL with the ROS to form a EPR silent compound; continuously recording the EPR signal.

### STATEMENT REGARDING PRIOR DISCLOSURE BY THE INVENTORS

Aspects of this technology are described in a conference abstract “A direct monitoring method of titania photocatalytic activity by an in situ photoreactor-EPR setup” from the 61st Annual Rocky Mountain Conference on Magnetic Resonance, Jul. 25, 2022, which is incorporated herein by reference in its entirety.

Aspects of this technology are described in an article “Semi-automated EPR system for direct monitoring the photocatalytic activity of TiO₂ suspension using TEMPOL model compound,” Photochemical & Photobiological Sciences, Volume 21, Aug. 13, 2022, 2071-2083, which is incorporated herein by reference in its entirety.

### STATEMENT OF ACKNOWLEDGEMENT

This research was supported by King Fahd University of Petroleum and Minerals under the internal grant DF181025.

### BACKGROUND

### Technical Field

The present disclosure is directed to photocatalysis, more particularly, an EPR method for evaluating the photocatalytic activity of a photocatalytic substance.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly nor impliedly admitted as prior art against the present invention.

Nowadays, photocatalysis has gathered much attention because it can be used in various environmental and energy applications. Traditionally, titanium dioxide (TiO₂), among many semiconductors, has been used in ecological photocatalysis because it is non-toxic, inexpensive, and chemically and biologically inert [Paušová, Š., Riva, M., Baudys, M., Krýsa, J., Barbieriková, Z. & Brezová, V. (2019). Composite materials based on active carbon/TiO₂ for photocatalytic water purification. Catalysis Today, 328, 178-182; Tetteh, E. K., Rathilal, S., Asante-Sackey, D. & Chollom, M. N. (2021). Prospects of Synthesized Magnetic TiO₂-Based Membranes for Wastewater Treatment: A Review. Materials, 14, 3524]. In recent years, photocatalysis has been involved in many practical applications, including self-cleaning glass, tent/awning materials, odor-removing paint for indoor applications, NOₓ removing paint, concrete and tiles for exterior applications, photo-induced sterile surfaces (ceramics and metals), water and air purification units, and defogging mirror. As a result, many photocatalytic materials have been developed in the past few years to meet the growing demand for photocatalysts. However, there is still a lack of standard methods for evaluating photocatalytic activity of those materials at different occasions.

Recently, eight methods have been published by ISO, a leading publisher of international standards. [Mills, A., Hill, C. & Robertson, P. K. (2012). Overview of the current ISO tests for photocatalytic materials. Journal of Photochemistry and Photobiology A: Chemistry, 237, 7-23]. These methods focused on: air purification [Yan, X., Ohno, T., Nishijima, K., Abe, R. & Ohtani, B. (2006). Is methylene blue an appropriate substrate for a photocatalytic activity test? A study with visible-light responsive titania? Chemical Physics Letters, 429, 606-610; and Kim, S. & Choi, W. (2005). Visible-light-induced photocatalytic degradation of 4-chlorophenol and phenolic compounds in aqueous suspension of pure titania: demonstrating the existence of a surface-complex-mediated path. The Journal of Physical Chemistry B, 109, 5143-5149]; water purification [Ganharul, G. K. Q., Tofanello, A., Bonadio, A., Freitas, A. L., Escote, M. T., Polo, A. S., Nantes-Cardoso, I. L. & Souza, J. A. (2021). Disclosing the hidden presence of Ti³⁺ ions in different TiO₂ crystal structures synthesized at low temperatures and photocatalytic evaluation by methylene blue photobleaching. Journal of Materials Research, 36, 3353-3365; and He, W., Liu, Y., Wamer, W. G. & Yin, J.-J. (2014). Electron spin resonance spectroscopy for the study of nanomaterial-mediated generation of reactive oxygen species. Journal of food and drug analysis, 22, 49-63]; self-cleaning surfaces [Morsy, M. A. & Kawde, A.-N. M. (2015). Electron paramagnetic resonance monitoring for on-demand electrochemically-generated radicals. Electrochimica Acta, 160, 22-27]; photo sterilization [Goldstein, S., Behar, D. & Rabani, J. (2009). Nature of the oxidizing species formed upon UV photolysis of C—TiO₂ aqueous suspensions. The Journal of Physical Chemistry C, 113, 12489-12494]; and UV light sources assessments [Schneider, J., Matsuoka, M., Takeuchi, M., Zhang, J., Horiuchi, Y., Anpo, M. & Bahnemann, D. W. (2014). Understanding TiO₂ Photocatalysis: Mechanisms and Materials. Chem. Rev., 114, 9919-9986]. Three of these standard methods are dedicated to air purification by removing NO [Yan, X., Ohno, T., Nishijima, K., Abe, R. & Ohtani, B. (2006). Is methylene blue an appropriate substrate for a photocatalytic activity test? A study with visible-light responsive titania. Chemical Physics Letters, 429, 606-610], acetaldehyde [Kim, S. & Choi, W. (2005). Visible-light-induced photocatalytic degradation of 4-chlorophenol and phenolic compounds in aqueous suspension of pure titania: demonstrating the existence of a surface-complex-mediated path. The Journal of Physical Chemistry B, 109, 5143-5149], or toluene [Bahnemann, D., Bockelmann, D. & Goslich, R. (1991). Mechanistic studies of water detoxification in illuminated TiO₂ suspensions. Solar Energy Materials, 24, 564-583]. For the assessment of the photocatalytic activity towards water purification, the photobleaching of methylene blue (MB) [Ganharul, G. K. Q., Tofanello, A., Bonadio, A., Freitas, A. L., Escote, M. T., Polo, A. S., Nantes-Cardoso, I. L. & Souza, J. A. (2021). Disclosing the hidden presence of Ti³⁺ ions in different TiO₂ crystal structures synthesized at low temperature and photocatalytic evaluation by methylene blue photobleaching. Journal of Materials Research, 36, 3353-3365] and oxidation of DMSO [He, W., Liu, Y., Wamer, W. G. & Yin, J.-J. (2014). Electron spin resonance spectroscopy for the study of nanomaterial-mediated generation of reactive oxygen species. Journal of food and drug analysis, 22, 49-63] are used. MB was questionable, particularly for the slurry reactor, due to the high capacity of dark adsorption, dye-self degradation, and photosensitization [Yan, X., Ohno, T., Nishijima, K., Abe, R. & Ohtani, B. (2006). Is methylene blue an appropriate substrate for a photocatalytic activity test-A study with visible-light responsive titania. Chemical Physics Letters, 429, 606-610]. Therefore, the MB bleaching test is not recommended for assessing the activity of visible light active-photocatalyst, where a colorless probe is preferable.

As a better replacement of MB, phenolic compounds have been used as substrates for the photocatalytic assessments of water purification [He, W., Liu, Y., Wamer, W. G. & Yin, J.-J. (2014). Electron spin resonance spectroscopy for the study of nanomaterial-mediated generation of reactive oxygen species. Journal of food and drug analysis, 22, 49-63]. Still, these substrates also suffer from the photosensitization effect due to the surface complexation with some photocatalysts such as TiO₂ [Kim, S. & Choi, W. (2005). Visible-light-induced photocatalytic degradation of 4-chlorophenol and phenolic compounds in aqueous suspension of pure titania: demonstrating the existence of a surface-complex-mediated path. The Journal of Physical Chemistry B, 109, 5143-5149]. In all of the water purification standard methods, the samples need to be filtrated before the analysis either by UV-Vis. spectrophotometer, high-performance liquid chromatography (HPLC), or total organic carbon analyzer (TOC).

A direct test for assessing the photocatalytic activity includes using a suspension of a photocatalyst uses (potentiometric titration) pH-titration and dichloroacetic acid or chloroform as a model compound [Bahnemann, D., Bockelmann, D. & Goslich, R. (1991). Mechanistic studies of water detoxification in illuminated TiO₂ suspensions. Solar Energy Materials, 24, 564-583]. In this test, pH-titration is used to determine the released H⁺-amount from the photocatalytic oxidation of halogenated hydrocarbons in reactions shown in Eq. 1 and Eq. 2 of dichloroacetic acid and chloroform, respectively.

$${CHCl}_{2} {COO}^{-} + {O}_{2} {\to }^{hv , {TiO}_{2}} 2 {CO}_{2} + {H}^{+} + 2 {Cl}^{-} \qquad ( 1 )$$

$${CHCl}_{3} + \frac{1}{2} {O}_{2} + {H}_{2} O {\to }^{hv , {TiO}_{2}} {CO}_{2} + 3 {H}^{+} + 3 {Cl}^{-} \qquad ( 2 )$$

Using a pH sensor in the sticky TiO₂ suspension limits the application and sensitivity of this method, and the titrant NaOH needs to be kept under argon and standardized weekly. Thus, the development of a direct way to assess the photocatalytic activity of photocatalyst suspension remains highly required.

The suspended photocatalytic processes generally start in water and aerobic atmosphere, demonstrating the relevance of both oxygen and water [Obregón, S., Ruíz-Gómez, M. A. & Hernández-Uresti, D. B. (2017). Direct evidence of the photocatalytic generation of reactive oxygen species (ROS) in a Bi2W2O9 layered structure. Journal of colloid and interface science, 506, 111-119; and Nosaka, Y. & Nosaka, A. Y. (2017). Generation and Detection of Reactive Oxygen Species in Photocatalysis. Chem. Rev., 117, 11302-11336]. Upon photon absorption by the photocatalyst, electron (e⁻)/hole (h⁺) pairs are generated in the conduction/valance bands, respectively. The photogenerated holes and electrons are either dissipated as heat or diffused to the surface of the photocatalyst to generate reactive oxygen species (ROS) [Kumar, A. & Pandey, G. (2017). A review on the factors affecting the photocatalytic degradation of hazardous materials. Mater. Sci. Eng. Int. J, 1, 1-10]. The ROSs are primarily in the form of hydroxyl radical (·OH), superoxide anion radical (·O₂⁻), singlet oxygen (¹O₂), or hydrogen peroxide (H₂O₂) [Nosaka, Y. & Nosaka, A. Y. (2017). Generation and Detection of Reactive Oxygen Species in Photocatalysis. Chem. Rev., 117, 11302-11336]. It is commonly agreed that the photocatalytic degradation of organic pollutants is initiated by a reaction with the hydroxyl radical (either free or trapped) [Turchi, C. S. & Ollis, D. F. (1990). Photocatalytic degradation of organic water contaminants: mechanisms involving hydroxyl radical attack. Journal of catalysis, 122, 178-192]. Thus, the assessment of the activity by the detection of ·OH radical is representative.

Electron paramagnetic resonance (EPR) spectroscopy is a powerful method to detect free radicals [He, W., Liu, Y., Wamer, W. G. & Yin, J.-J. (2014). Electron spin resonance spectroscopy for the study of the nanomaterial-mediated generation of reactive oxygen species. Journal of food and drug analysis, 22, 49-63; and Morsy, M. A. & Kawde, A.-N. M. (2015). Electron paramagnetic resonance monitoring for on-demand electrochemically-generated radicals. Electrochimica Acta, 160, 22-27]. EPR may detect the trapped ·OH radicals using 5,5-dimethyl-1-pyrroline N-oxide (DMPO) as a spin trapper to form nitroxide radicals. Unfortunately, DMPO is not stable, and it is expensive.

Although methods for evaluating the photocatalytic activity of a photocatalytic substance by monitoring the rate of methylene blue bleaching, and phenols degradation are known, these methods suffer from many drawbacks, e.g., the high capacity of dark adsorption, self-degradation, and photosensitization. Besides, filtration is always required to separate the particulate photocatalyst before the analysis. Therefore, there still exists a need to develop new compounds and methods that overcome the limitations of conventional methods.

In view of the forgoing, one objective of the present disclosure is to describe a method for monitoring and evaluating the photocatalytic activity of a photocatalytic substance.

### SUMMARY

In an exemplary embodiment, a method for monitoring and evaluating the photocatalytic activity of a photocatalytic substance is described. The method includes mixing and dissolving 4-hydroxy-2,2,6,6-tetramethylpiperidine-N-oxyl (TEMPOL) in a liquid to form a TEMPOL solution. The method also dispersing particles of the photocatalytic substance in the TEMPOL solution to form a photocatalytic suspension. The method further includes purging the photocatalytic suspension by introducing a gas composition to a reactor containing the photocatalytic suspension under continuous agitation in the dark to form a purged photocatalytic suspension. The method involves illuminating the purged photocatalytic suspension in the reactor with a light to initiate a photocatalytic reaction and generate a reactive oxygen species (ROS) that is detectable by an electron paramagnetic resonance (EPR) spectrometer. In addition, the method involves introducing a portion of the purged photocatalytic suspension via the sample inlet to the EPR cell in the cavity of the EPR spectrometer to generate an EPR signal by detecting the reactive oxygen species and recirculating the portion of the purged photocatalytic suspension back to the reactor via the sample outlet after passing through the EPR cell. Furthermore, the method involves reacting TEMPOL with the reactive oxygen species to form a EPR silent compound thereby reducing the intensity of the EPR signal generated by the reactive oxygen species. The method also involves continuously recording the EPR signal.

In some embodiments, the EPR spectrometer contains an EPR cell having a sample inlet and a sample outlet, a cavity for holding the EPR cell, at least two magnet components that are adjacent to the cavity to generate a magnetic field around the cavity, and a pump for conveying the purged photocatalytic suspension to the EPR cell.

In some embodiments, the EPR signal is numerically digitally displayed and visually displayed to monitor and evaluate the photocatalytic activity of the photocatalytic substance suspended in the liquid.

In some embodiments, the photocatalytic substance is at least one selected from the group consisting of zinc oxide, tin oxide, iron oxide, dibismuth trioxide, tungsten trioxide, strontium titanate, titanium dioxide, and a mixture thereof.

In some embodiments, the photocatalytic substance is titanium dioxide, and wherein the titanium dioxide comprises at least one selected from the group consisting of a flame pyrolysis-treated titanium dioxide, a nitrogen-doped titanium dioxide, and a plasma-treated titanium dioxide.

In some embodiments, the titanium dioxide is at least one selected from the group consisting of rutile-type titanium dioxide, anatase-type titanium dioxide, brookite-type titanium dioxide, titanium dioxide P25, and a mixture thereof.

In some embodiments, the photocatalytic substance has an average particle size of 0.2 to 1 micrometers (μm).

In some embodiments, the photocatalytic substance is present in the photocatalytic suspension at a concentration of 0.05 to 5 milligrams per milliliter (mg/ml) based on a total volume of the TEMPOL solution.

In some embodiments, the photonic efficiency of the photocatalytic suspension has a linear dependence on the square root of the light intensity.

In some embodiments, the TEMPOL solution has a concentration of 10 to 1000 micromolars (μM).

In some embodiments, the TEMPOL solution has a concentration of 200 to 300 μM.

In some embodiments, the TEMPOL does not absorb the light. In some embodiments, the photocatalytic substance does not absorb the TEMPOL under dark conditions.

In some embodiments, the TEMPOL has at least one peak in the range of 320 to 350 magnetic field (mT) on an EPR spectrum with a g-value of 1.97 to 2.03.

In some embodiments, the light comprises UV light and visible light, and wherein the light has an intensity in a range of 0.5 to 80 milliwatts per square centimeter (mW cm⁻²).

In some embodiments the gas composition comprises at least one gas selected from the group consisting of air, nitrogen, and oxygen.

In some embodiments, the EPR signal is collected at a modulation frequency of 50 to 200 kilohertz (kHz) by the EPR spectrometer.

In some embodiments, the EPR is collected at a sweep time of 5 to 20 seconds (s) and a width of 5 to 20 mT by the EPR spectrometer.

In some embodiments, the EPR is collected at an amplitude attenuation of 1 to 5 milliwatts (mW), and an amplitude modulation of 50 to 400 microteslas (μT) by the EPR spectrometer.

In some embodiments, the reactive oxygen species present in the photocatalytic suspension is in the form of at least one selected from the group consisting of hydroxyl radical (·OH), superoxide anion radical (·O₂⁻), singlet oxygen (¹O₂), and hydrogen peroxide (H₂O₂).

In some embodiments, the EPR silent compound is at least one selected from the group consisting of 4-oxo-2,2,6,6-tetramethylpiperidine-1-oxyl radical (TEMPONE), 4-oxo-2,2,6,6-tetramethylpiperidine, and 4-hydroxyl-tetramethypiperidine, and wherein the EPR silent compound results in a decay of the EPR signal.

In some embodiments, filtration is not required to separate the photocatalytic substance from the photocatalytic suspension before analysis compared to methods involving photosensitive compounds (e.g., methylene blue bleaching and phenolic compounds) that requires filtration before analysis.

In some embodiments, the photocatalytic substance has a EPR signal intensity of 5×10³ to 75×10³ astronomical (a.u.) at a light intensity of 0.5 to 80 mW cm⁻².

The foregoing general description of the illustrative present disclosure and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 is a schematic flow chart of a method of monitoring and evaluating the photocatalytic activity of a photocatalytic substance, according to certain embodiments;

FIG. 2 illustrates a schematic illustration of Electron Paramagnetic Resonance (EPR)-photocatalyst setup (LHS) and its used flow cell (RHS), according to certain embodiments;

FIG. 3A depicts a typical EPR signal of 100 μM 4-hydroxy-2,2,6,6-tetramethylpiperidine-N-oxyl (TEMPOL) aqueous solution, according to certain embodiments;

FIG. 3B depicts a long-term stability test of the TEMPOL aqueous solution at ambient temperature, according to certain embodiments;

FIG. 3C depicts a stability test for TEMPOL in water under UV(A) light (7 mW cm⁻²) and in dark, in an aqueous suspension of TiO₂, according to certain embodiments;

FIG. 3D depicts UV-Visible (UV-Vis.) spectra of the TEMPOL aqueous solution, according to certain embodiments;

FIG. 4 depicts intensities of the EPR signals recorded for the filtrated TEMPOL aqueous suspensions after shaking for different time periods, namely, 5 h and 11 h, in the dark, according to certain embodiments;

FIG. 5 depicts overlaid EPR signals for photocatalytic deactivation of TEMPOL in presence of TiO₂ P25, under UV(A) light illumination, according to certain embodiments;

FIG. 6A is a plot depicting time course of photocatalytic deactivation of TEMPOL in the presence of TiO₂ P25, under UV(A) light illumination, according to certain embodiments;

FIG. 6B is a plot depicting kinetics of photocatalytic deactivation of TEMPOL in the presence of TiO₂ P25, under UV(A) light illumination, according to certain embodiments;

FIG. 7A is a plot depicting an influence of TEMPOL concentration on photocatalytic deactivation of TEMPOL under UV(A) light illumination, according to certain embodiments;

FIG. 7B is a plot depicting TiO₂ P25 loading on an initial rate (R₀) of photocatalytic deactivation of TEMPOL under UV(A) light illumination, according to certain embodiments;

FIG. 8A is a plot depicting the time course of photocatalytic deactivation of TEMPOL in presence of TiO₂ P25 under UV(A) light illumination at different intensities, according to certain embodiments;

FIG. 8B depicts the kinetics of photocatalytic deactivation of TEMPOL in the presence of TiO₂ P25 under UV(A) light illumination at different intensities, according to certain embodiments;

FIG. 8C is a plot of the initial rate (R₀) and photonic efficiency (ξ₀) versus photon flux, according to certain embodiments;

FIG. 8D is a plot of log(ξ₀) versus a photon flux log(Iₕᵥ), according to certain embodiments;

FIG. 9 depicts a rate of the photocatalytic deactivation of TEMPOL over TiO₂ P25 under UV(A) light illumination in the presence and absence of an electron acceptor (i.e., O₂) and the presence of methanol as an electron donor, according to certain embodiments;

FIG. 10A depicts the EPR signal recorded after one hour of the photocatalytic deactivation of 100 μM TEMPOL purged with dry air, according to certain embodiments;

FIG. 10B depicts a ¹H-NMR spectrum of non-radical products extracted in deuterated chloroform after the photocatalytic deactivation of 1000 μM TEMPOL after 8 h irradiation, according to certain embodiments;

FIG. 10C depicts ¹³C-NMR spectra of the non-radical products extracted in deuterated chloroform after the photocatalytic deactivation of 1000 μM TEMPOL after 8 h irradiation, according to certain embodiments;

FIG. 11 is a schematic illustration depicting hydroxyl radical deactivation of TEMPOL in the presence of air and nitrogen to form TEMPONE and non-radical 4-oxo-tetramethylpiperidine in addition to starting materials, according to certain embodiments;

FIG. 12A is an EPR signal recorded after one hour of the photocatalytic deactivation of 100 μM TEMPOL in the presence of 100 mM methanol and purged with dry air, according to certain embodiments;

FIGS. 12B and 12C depict a ¹H-NMR spectrum of the non-radical products extracted in deuterated chloroform after the photocatalytic deactivation of 1000 μM TEMPOL after 8 h irradiation, according to certain embodiments;

FIG. 13 is a schematic illustration depicting the hydroxyl radical deactivation of TEMPOL in the presence of methanol to form non-radical 4-hydroxy-tetramethylpiperidine as a primary product and a tiny amount of both TEMPONE (minor product) and TEMPOL starting materials according to certain embodiments;

FIG. 14A is a plot depicting a time course of photocatalytic TEMPOL deactivation, over TiO₂ P25, anatase, brookite, and rutile photocatalysts under UV(A) light illumination, according to certain embodiments; and

FIG. 14B is a plot depicting methanol oxidation over the TiO₂ P25, anatase, brookite, and rutile photocatalysts under UV(A) light illumination, according to certain embodiments.

### DETAILED DESCRIPTION

In the drawings, like reference numerals designate identical or corresponding parts throughout the several views. Further, as used herein, the words “a,” “an” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values there between.

Aspects of the present disclosure are directed to the use of electron paramagnetic resonance (EPR) and 4-hydroxy-2,2,6,6-tetramethylpiperidine-N-oxyl (TEMPOL) to directly monitor the photocatalytic activity of a TiO₂ suspension without the need for filtration. The TEMPOL aqueous solution exhibits outstanding stability in the dark and under UV(A) illumination, does not absorb UV(A) and visible light, and has negligible dark adsorption. The influence of TEMPOL concentration, light intensity, and TiO₂ loading on the photocatalytic deactivation rate is disclosed. The mechanisms of TEMPOL deactivation in the presence and absence of oxygen, as well as, in the presence of methanol ·OH radicals' scavenger, are discussed. The photocatalytic deactivation products have been analyzed using EPR, ¹H-NMR, and ¹³C-NMR spectroscopies. It was found that the deactivation of TEMPOL is initiated by ·OH radicals and α-H abstraction from the 4-piperidine position followed by the formation of TEMPONE (4-oxo-2,2,6,6-tetramethylpiperidine-1-oxyl) and 4-oxo-2,2,6,6-tetramethylpiperidine). In the presence of methanol, the formed α-hydroxyl radicals (·CH₂OH) attack the nitroxide side of TEMPOL and produce 4-hydroxy-tetramethylpiperidine. The same activity trends have been observed for the photocatalytic methanol oxidation and TEMPOL deactivation over different types of TiO₂ photocatalysts, evincing that the method is useful for direct monitoring of the activities of photocatalyst suspensions.

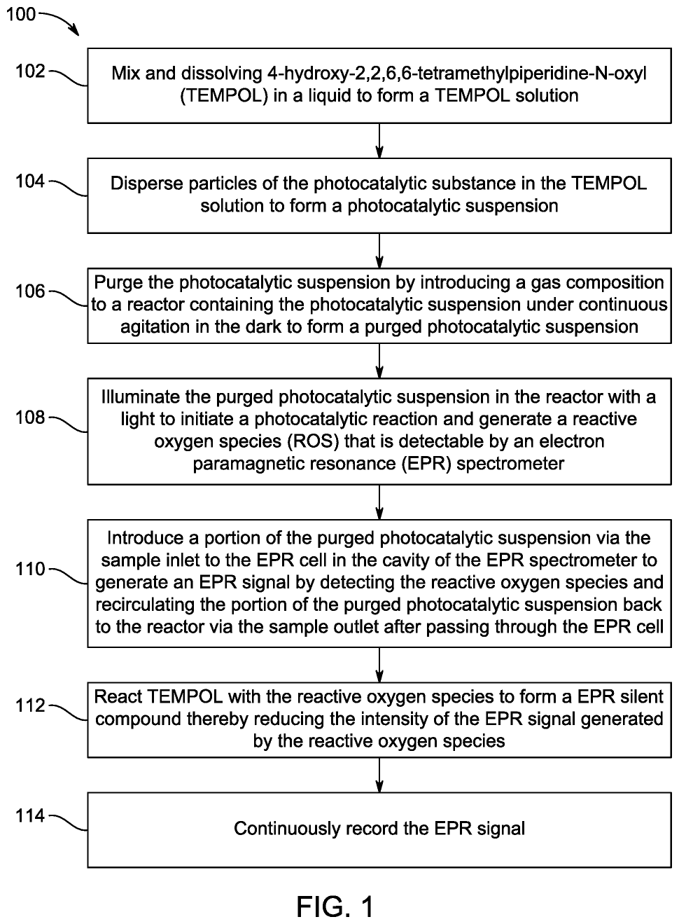

FIG. 1 illustrates a schematic flow chart of a method 100 of monitoring and evaluating the photocatalytic activity of a photocatalytic substance. The order in which the method 100 is described is not intended to be construed as a limitation, and any number of the described method steps can be combined in any order to implement the method 100. Additionally, individual steps may be removed or skipped from the method 100 without departing from the spirit and scope of the present disclosure.

At step 102, the method 100 includes mixing and dissolving 4-hydroxy-2,2,6,6-tetramethylpiperidine-N-oxyl (TEMPOL) in a liquid to form a TEMPOL solution. In some embodiments, the liquid is water. In some embodiments, the TEMPOL solution has a concentration of 10 to 1000 μM, preferably 15 to 750 μM, preferably 20 to 500 μM, and more particularly, about 25-250 μM. In some embodiments, the mixing is performed at a mixing speed of 50 to 5000 revolutions per minute (rpm), preferably 100 to 3000 rpm, preferably 150 to 1000 rpm, or even more preferably 200 to 500 rpm. In some embodiments, the mixing speed may be a fixed speed, a stepped speed, a continuously varying speed, an oscillating speed, and/or a controlled speed. Other ranges are also possible.

At step 104, the method includes dispersing particles of the photocatalytic substance in the TEMPOL solution to form a photocatalytic suspension. As used herein, the term “photocatalytic substance” is not limited to a single photocatalytic substance but also includes combinations of two or more compounds with photocatalytic activity. It is preferred that the concentration of the photocatalytic substance present in the photocatalytic suspension is about 0.05 to 5 milligrams per milliliter (mg/ml) based on the total volume of the TEMPOL solution, preferably 0.1 to 4 mg/ml, preferably 0.2 to 3 mg/ml, or even more preferably 0.5 to 1 mg/ml, based on the total volume of the TEMPOL solution. In some embodiments, the photocatalytic substance is at least one selected from the group consisting of zinc oxide, tin oxide, iron oxide, dibismuth trioxide, tungsten trioxide, strontium titanate, titanium dioxide, and a mixture thereof. In some embodiments, the photocatalytic substance has an average particle size of 0.2 to 1 μm, preferably 0.3 to 0.9 μm, preferably 0.4 to 0.8 μm, or even more preferably 0.5 to 0.7 μm. In some further embodiments, the photocatalytic substance has an average particle size of 5 to 200 nanometers (nm), preferably 10 to 100 nm, preferably 15 to 50 nm, or even more preferably 20 to 30 nm. Other ranges are also possible.

In a preferred embodiment, the photocatalytic substance is titanium dioxide. In some further embodiments, the titanium dioxide includes flame pyrolysis-treated titanium dioxide, nitrogen-doped titanium dioxide, plasma-treated titanium dioxide, and a mixture thereof. TiO₂ can exist in an amorphous form or in a crystalline form, and there are at least three crystalline forms that may exist in the TiO₂ crystalline at ambient temperature, such as rutile phase, anatase phase, and brookite phase. The method is preferably applied to the TiO₂ present in crystalline anatase phase. In some most preferred embodiments, the titanium dioxide is TiO₂ P25. In some embodiments, the TiO₂ P25 comprises rutile phase TiO₂ and anatase phase TiO₂. In some further embodiments, a phase ratio of the rutile phase TiO₂ and the anatase phase TiO₂ is in a range of 20:1 to 1:20, preferably 10:1 to 1:15, preferably 1:1 to 1:10, or even more preferably 1:5 to 1:8. In some preferred embodiments, the TiO₂ contains at least 80% anatase phase TiO₂ based on a total number of TiO₂ molecules, preferably at least 85%, preferably at least 90%, preferably at least 95%, or even more preferably at least 99% anatase phase TiO₂, based on the total number for the TiO₂ molecules. In some more preferred embodiments, the TiO₂ molecules have an average particle size in a range of 5 to 100 nm, preferably 10 to 50 nm, preferably 15 to 30 nm, or even more preferably 20 to 25 nm. Other ranges are also possible.

At step 106, the method 100 includes purging the photocatalytic suspension by introducing a gas composition to a reactor containing the photocatalytic suspension under continuous agitation in the dark to form a purged photocatalytic suspension. In some embodiments, the photocatalytic suspension was kept under shaking (centrifugation/manual) at a speed of 100-400 rpm, preferably 150 to 350 rpm, preferably 200 to 300 rpm, or even more preferably about 250 rpm. In some further embodiments, the photocatalytic suspension was kept in the dark for a period of 3-12 hours, preferably 5 to 10 hours, or even more preferably 7 to 9 hours. In some further preferred embodiments, the photocatalytic suspension was kept at a temperature in a range of 22-37° C., preferably 22 to 30° C., or even more preferably about 25° C. Other ranges are also possible.

In some embodiments, the gas composition includes at least one gas selected from the group consisting of regular air, dry air, nitrogen, and oxygen. In some embodiments, the gas composition, including nitrogen, is introduced into the reactor to form the purged photocatalytic suspension. In some embodiments, the gas composition, including dry air, is introduced into the reactor to form the purged photocatalytic suspension. In some further embodiments, the purging is performed for at least 15 minutes, preferably at least 60 minutes, preferably at least 120 minutes, or even more preferably at least 240 minutes. Other ranges are also possible.

At step 108, the method 100 includes illuminating the purged photocatalytic suspension in the reactor with a light to initiate a photocatalytic reaction and generate a reactive oxygen species (ROS) that is detectable by an electron paramagnetic resonance (EPR) spectrometer. The light includes UV light and visible light. In some embodiments, the light has an intensity in a range of 0.5 to 80 mW cm⁻², preferably 1 to 50 mW cm⁻², preferably 3 to 30 mW cm⁻², preferably 5 to 10 mW cm⁻², or even more preferably about 7 mW cm⁻². In some embodiments, the TEMPOL does not absorb the light; however, the photocatalytic suspension, on absorbing the light, results in the generation of electron/hole pairs. In some preferred embodiments, the electrons further react with the molecular oxygen, present in the reactor, to generate the ROS. The ROS present in the photocatalytic suspension is in the form of at least one selected from the group consisting of hydroxyl radical (·OH), superoxide anion radical (·O₂⁻), singlet oxygen (¹O₂), and hydrogen peroxide (H₂O₂). Other ranges are also possible.

In some embodiments, the EPR spectrometer comprises an EPR cell that has a sample inlet and a sample outlet, a cavity for holding the EPR cell, at least two magnet components that are adjacent to the cavity to generate a magnetic field around the cavity, and a pump for conveying the purged photocatalytic suspension to the EPR cell.

At step 110, the method 100 includes introducing a portion of the purged photocatalytic suspension via the sample inlet to the EPR cell in the cavity of the EPR spectrometer to generate an EPR signal by detecting the reactive oxygen species and recirculating the portion of the purged photocatalytic suspension back to the reactor via the sample outlet after passing through the EPR cell. The intensity of the EPR signal at this point is measured at t=0. The EPR is conducted at an amplitude attenuation of 1 to 5 milliwatts (mW), preferably 1.5 to 4.5 mW, preferably 2 to 4 mW, or even more preferably about 3 mW. In some embodiments, the EPR is conducted at an amplitude modulation of 50 to 400 microteslas (μT), preferably 100 to 350 μT, preferably 150 to 300 μT, or even more preferably 200 to 250 μT. In some further embodiments, the EPR is conducted at a sweep time of 5 to 20 seconds (s), preferably 8 to 17 s, preferably 11 to 14 s, or even more preferably about 12 s. In some preferred embodiments, the EPR is conducted at a width of 5 to 20 mT, preferably 8 to 17 mT, preferably 11 to 14 mT, or even more preferably about 12 mT. In some more preferred embodiments, the EPR is conducted at a modulation frequency of 50 to 200 kilohertz (kHz), preferably 80 to 170 kHz, preferably 110 to 140 kHz, or even more preferably about 120 kHz. The TEMPOL has at least one peak in the range of 320 to 350 magnetic field (mT), preferably 325 to 345 mT, or even more preferably 330 to 340 mT, on an EPR spectrum with a g-value of 1.97 to 2.03. The method further includes recirculating the portion of the purged photocatalytic suspension back to the reactor via the sample outlet after passing through the EPR cell. Other ranges are also possible.

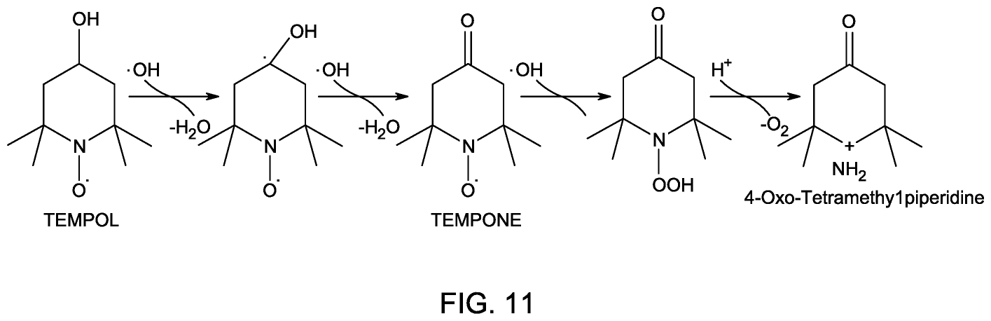

At step 112, the method 100 includes reacting TEMPOL with the reactive oxygen species to form a EPR silent compound thereby reducing the intensity of the EPR signal generated by the reactive oxygen species, and the ROS is described in the examples, and FIG. 11. In some embodiments, the EPR silent compound is at least one selected from the group consisting of 4-oxo-2,2,6,6-tetramethylpiperidine-1-oxyl radical (TEMPONE), 4-oxo-2,2,6,6-tetramethylpiperidine, and 4-hydroxyl-tetramethypiperidine. The formation of the EPR silent compound results in a decay of the EPR signal. The decay of the EPR signal is indicative of the end of the photocatalytic reaction. As depicted in FIG. 11, the TEMPOL reacts with the photogenerated OH· radicals to generate TEMPONE through α-proton abstraction at the 4-piperidine position of the TEMPOL ring. In some embodiments, the TEMPONE further reacts with the photogenerated OH· radicals to generate a peroxide intermediate at the 1-piperidine position of the TEMPOL ring. In some further embodiments, the peroxide intermediate may degrade and release oxygen to generate 4-oxo-tetramethylpiperidine.

At step 114, the method 100 includes continuously recording the EPR signal. The signal is numerically digitally displayed and visually displayed to monitor and evaluate the photocatalytic activity of the photocatalytic substance suspended in the liquid. In some embodiments, the EPR signal has an intensity of 5×10³ to 75×10³ astronomical (a.u.), preferably 10×10³ to 60×10³ a.u., preferably 20×10³ to 40×10³ a.u., or even more preferably about 30×10³ a.u., at a light intensity of 0.5 to 80 mW cm⁻², preferably 1 to 50 mW cm⁻², preferably 3 to 30 mW cm⁻², preferably 5 to 10 mW cm⁻², or even more preferably about 7 mW cm⁻². Other ranges are also possible.

The method of the present disclosure obviates the need for filtration to separate the photocatalytic substance from the photocatalytic suspension before analysis, compared to methods involving photosensitive compounds (e.g., methylene blue bleaching and phenolic compounds) that require filtration before analysis.

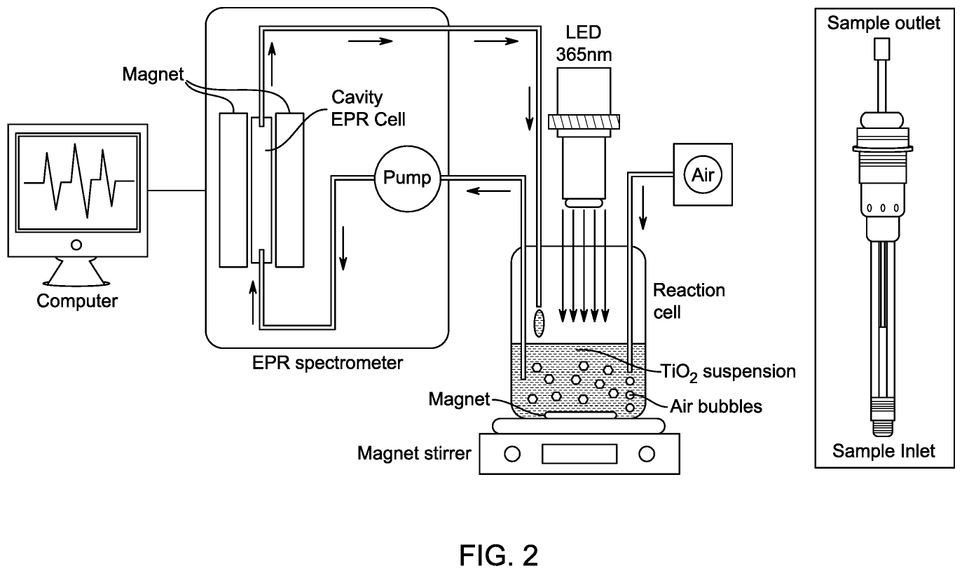

FIG. 2 illustrates an Electron Paramagnetic Resonance (EPR)-photocatalyst setup (LHS) and its used flow cell (RHS). The EPR spectrometer contains an EPR cell having a sample inlet and a sample outlet, a cavity for holding the EPR cell, at least two magnet components that are adjacent to the cavity to generate a magnetic field around the cavity, and a pump for conveying a sample to the EPR cell. In some embodiments, the EPR cell is in fluid communication with a photocatalytic reactor containing photocatalytic suspension via the sample inlet. In some embodiments, the sample inlet is connected to the pump for conveying the photocatalytic suspension to the EPR cell for real time analyzing the reactive oxygen species (ROS) without the need for filtration. In some embodiments, the EPR cell is in fluid communication with the photocatalytic reactor containing photocatalytic suspension via the sample outlet. The sample after analysis is circulated back to the photocatalytic suspension via the sample outlet. In some further embodiments, the EPR cell is configured to a computer device for processing the EPR signal generated by the EPR cell. In some preferred embodiments, the EPR signal is numerically digitally displayed and visually displayed to monitor and evaluate the photocatalytic activity of the photocatalytic substance suspended in the liquid. In some more preferred embodiments, the photocatalytic suspension present in the photocatalytic is illuminated under a collimated UV(A) light from a LED. In some further preferred embodiments, a distance between the photoreactor and the LED was kept constant, and the intensity of the UV(A) light may be adjusted by controlling the LED current. In some most preferred embodiment, an air inlet in connected to the photocatalytic reactor for purging the photocatalytic suspension before reacting. The purging may be conducted in the dark and/or under the light.

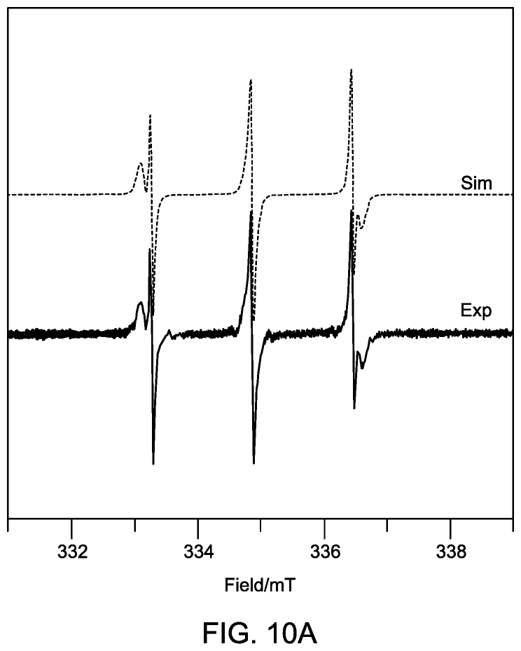

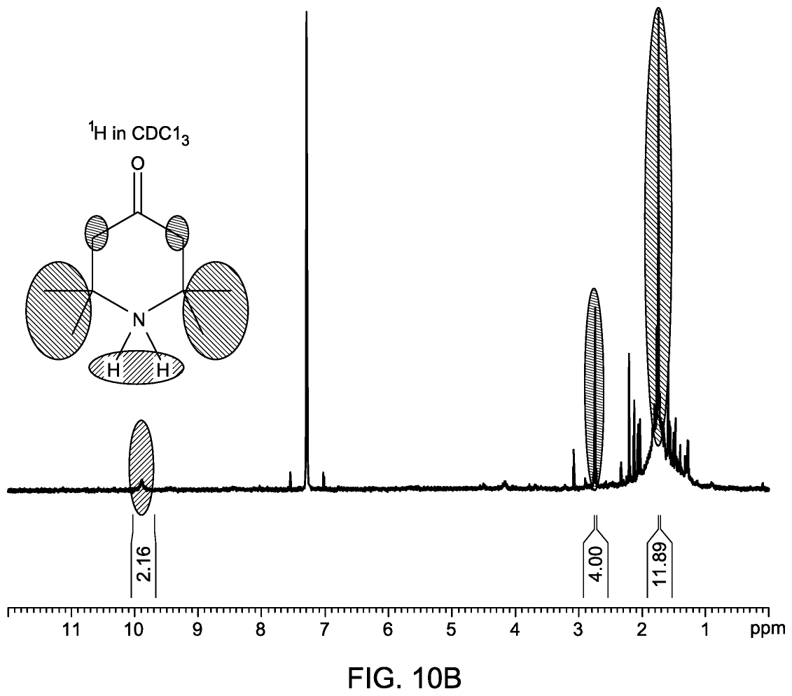

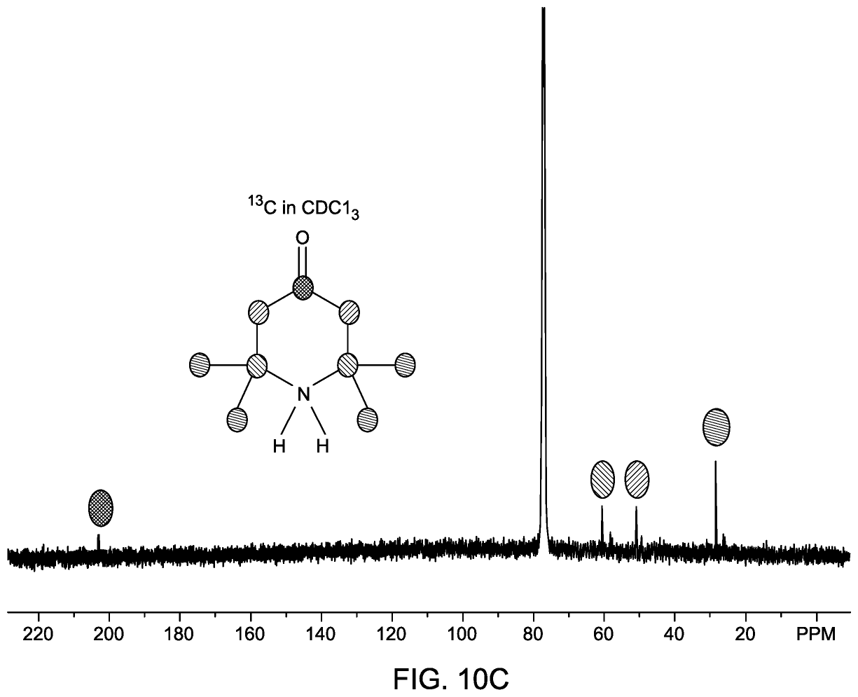

Referring to FIGS. 10B and 10C, NMR spectroscopic experiments are performed on a Bruker NMR 400 MHZ Avance III spectrometer (Bruker Corporation, Billerica, MA, USA). The photocatalytic suspension is filtered via a PTFE filtering having a pore size of 0.2 μm to form a filtrate. The filtrate is dried at a temperature of 20 to 80° C., preferably 30 to 60° C., or even more preferably about 50° C., and then dissolved in an organic solvent to form an NMR sample. The organic solvent may be at least one selected from the group consisting of chloroform, acetone, benzene, deuterium oxide, DMSO, ethanol, and methanol. The NMR sample is transferred into an NMR tube for collecting ¹H-NMR and ¹³C-NMR spectroscopy.

### EXAMPLES

The following examples describe and demonstrate exemplary embodiments of the method of monitoring and evaluating the photocatalytic activity of a photocatalytic substance, as described herein. The examples are provided solely for illustration and are not to be construed as limitations of the present disclosure, as many variations thereof are possible without departing from the spirit and scope of the present disclosure.

### Example 1: Materials and Methods

TiO₂ P25 was obtained from Evonik, Germany. In addition, 2,2,6,6-tetramethylpiperidine-1-oxyl (TEMPOL) were purchased from Sigma Aldrich and used as received. Double-distilled water (resistivity 18.2 MΩ cm) was used during all experiments.

### Example 2: EPR-Integrated Photocatalytic Setup and Photocatalytic Test

A customized X-band benchtop-EPR spectrometer from ADANI, known as ADANI-XLab, equipped with a built-in multi-capillary flow cell and a peristaltic pump, was used to record the EPR signal. The EPR signals were collected at a modulation frequency of 100 kHz. The sweep time and width were 10 s and 10 mT, respectively. The attenuation and modulation amplitudes were 3.16 mW and 200 μT, respectively. Sixty EPR scans were collected per photocatalytic test at a time interval of 1.0 min. In this setup, a 25 mL photo-reactor with a Thorlabs LED light source is attached to the EPR spectrometer with a capillary flow cell, schematically shown in FIG. 2.

In a typical photocatalytic test, 5 mg of TiO₂ P25 is dispersed in 10 mL of 100 μM TEMPOL solution by sonication in a 25 mL cylindrical photoreactor (inner diameter 30 mm). A smaller volume (within the range of 10-2 mL) can be analyzed based on the used photoreactor's inner diameter. The suspension is then kept under stirring and purging with air in the dark for 15 minutes. The photoreaction is connected to the EPR system, and the flow rate of the TiO₂ suspension into the EPR cell was controlled using the integrated peristaltic pump. It was adjusted to be 10 mL min⁻¹ and kept constant. After 180 s from starting the recording of the EPR signal, the light is turned on, and the photoreactor is illuminated from the top using a collimated UV(A) light using a high-power Thorlabs LED as a light source. The distance between the photoreactor and the LED was kept constant, and the light intensity was varied by controlling the LED current. The light intensity was measured by a calibrated Si-photodiode (FDS100-CAL, Thorlabs).

### Example 3: NMR Characterization of Photo-Deactivated TEMPOL Products

Several photocatalytic tests were conducted for NMR spectroscopic experiments, as explained in Example 2. At the end of the test, the suspended TiO₂ was separated by filtration using a syringe filter (Millipore, PTFE 0.2 μm), and the filtrates were subjected to complete slow vaporization at 50° C. The residues were then dissolved in chloroform and transferred into a regular 5-mm NMR tube. Finally, ¹H-NMR and ¹³C-NMR spectroscopy tests were performed to characterize the product using a Bruker NMR 400 MHZ Avance III spectrometer (Bruker Corporation, Billerica, MA, USA).

### Example 4: TEMPOL Stability Testing

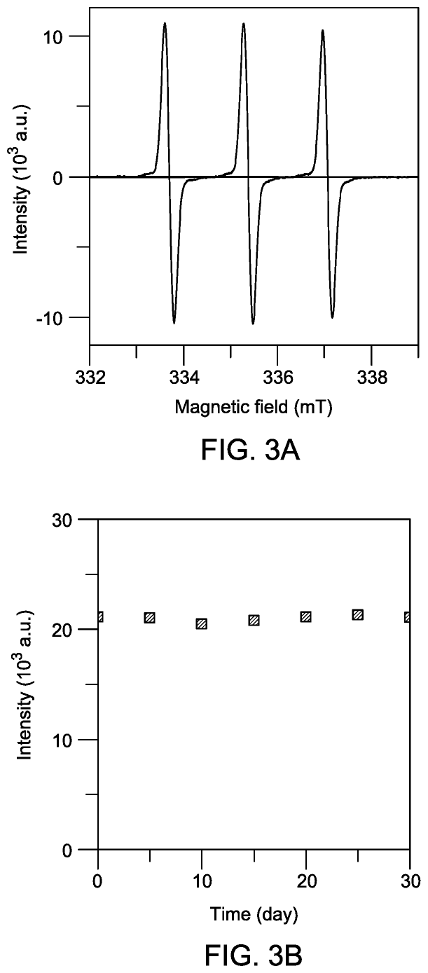

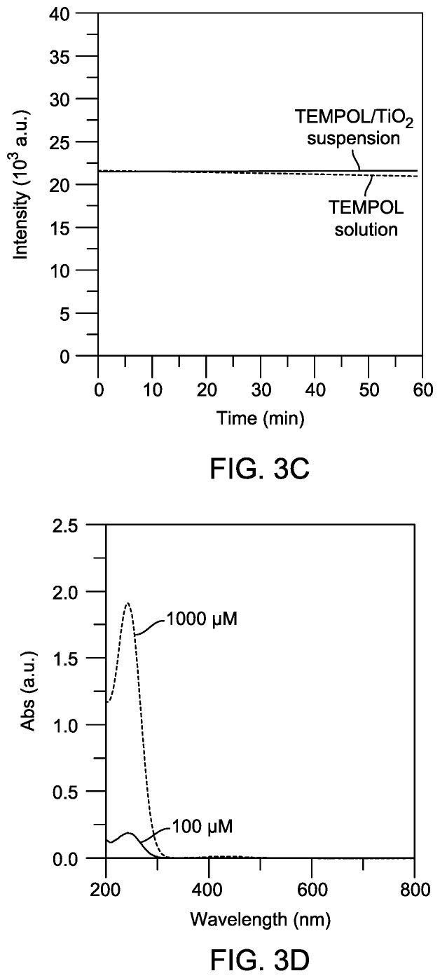

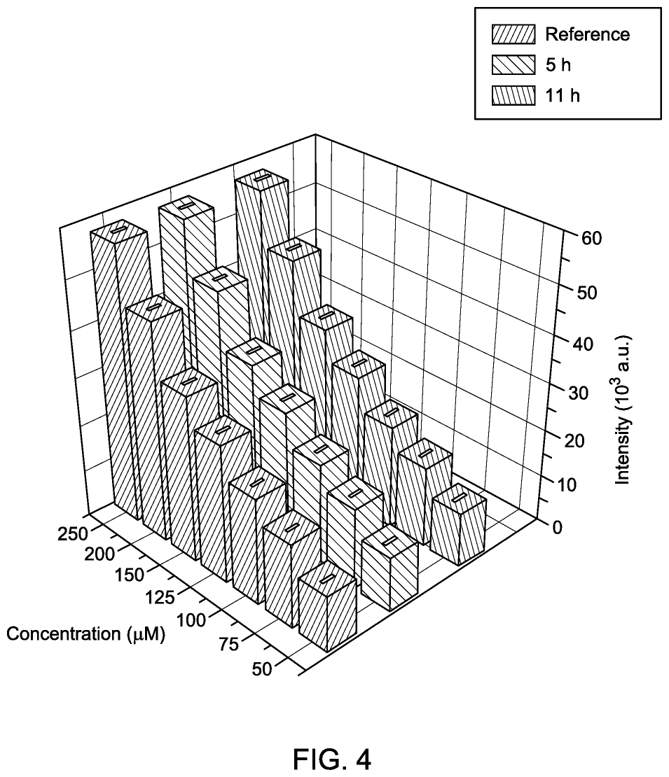

FIG. 3A shows a typical EPR signal of TEMPOL with a g-factor equal to 2.005554. TEMPOL's stability in water at ambient conditions was investigated by following the intensity of the EPR central signal of a field of 335 mT over 30 days (FIG. 3B). Almost the same intensities were observed; however, the aqueous solution of TEMPOL was left on the top of the bench during this period evincing that TEMPOL exhibits excellent stability in water under ambient conditions. The influence of UV(A) light on TEMPOL aqueous stability was also studied. As shown in FIG. 3C, considerable stability was observed, indicating that TEMPOL has excellent potential to be applied as a model compound to monitor photocatalytic activity. To assure that there is no dark reaction in the presence of TiO₂ photocatalyst, the EPR signal of TEMPOL in an aqueous suspension of TiO₂ is measured for 1 h. The central peak intensity values are compared to the clear TEMPOL solution, as shown in FIG. 3C. Again, a stable signal is observed, indicating that no reaction occurs in the dark. In addition to the high stability of TEMPOL, it does not absorb UV(A) and visible light (FIG. 3D). The study was performed with various concentrations (100 μM, and 1000 μM) and the results in both the cases indicate that the TEMPOL does not absorb light in both UV(A), and visible light. Thus, photosensitization associated with the dyes (e.g., MB) and phenolic compounds is avoided. Hence, photo-induced catalysis can be readily assured [Yan, X., Ohno, T., Nishijima, K., Abe, R. & Ohtani, B. (2006). Is methylene blue an appropriate substrate for a photocatalytic activity test? A study with visible-light responsive titania. Chemical Physics Letters, 429, 606-610; and Kim, S. & Choi, W. (2005). Visible-light-induced photocatalytic degradation of 4-chlorophenol and phenolic compounds in aqueous suspension of pure titania: demonstrating the existence of a surface-complex-mediated path. The Journal of Physical Chemistry B, 109, 5143-5149, which is incorporated herein by reference in its entirety] For dark adsorption measurements, 5 mg of TiO₂ P25 was dispersed in 10 mL aqueous solutions of TEMPOL with different concentrations (namely, 25, 50, 75, 100, 125, 150, 200, 250, and 300 μM). The concentration of TEMPOL at each tests was verified by using a calibration curve obtained from the EPR spectra of TEMPOL aqueous solutions measured under identified conditions. The prepared suspensions were kept under shaking at a speed of 200 rpm in the dark for 5 and 11 h at 25° C. The suspensions were then filtrated, and the EPR signals of each filtrate were recorded. The results of this study were compared with blank TEMPOL aqueous solutions (without adding titania). Concentrations of TEMPOL in the different suspensions were verified by comparing the intensity of the EPR spectra with that of the standard TEMPOL solutions, as shown in FIG. 4. Interestingly, no significant changes in the EPR signals have been observed even after 11 h of shaking compared to the blank samples, indicating that dark adsorption of TEMPOL on TiO₂ is negligible. According to the MB standard method, at least 12 hours are recommended to ensure the negligible influence of the dark adsorption on the rate of the photocatalytic reaction [Mills, A., Hill, C. & Robertson, P. K. (2012). Overview of the current ISO tests for photocatalytic materials. Journal of Photochemistry and Photobiology A: Chemistry, 237, 7-23]. Unlike MB, the TEMPOL can be directly used without spending a long time performing the photocatalytic test.

### Photocatalytic Deactivation of TEMPOL Over TiO₂ Suspension

### Example 5: EPR Response

In photocatalysis, reactive oxygen species (ROS) are generally generated upon the illumination of the TiO₂ photocatalyst suspension with photons that have higher energy than its bandgap [Goldstein, S., Behar, D. & Rabani, J. (2009). Nature of the oxidizing species formed upon UV photolysis of C—TiO₂ aqueous suspensions. The Journal of Physical Chemistry C, 113, 12489-12494; Schneider, J., Matsuoka, M., Takeuchi, M., Zhang, J., Horiuchi, Y., Anpo, M. & Bahnemann, D. W. (2014). Understanding TiO₂ Photocatalysis: Mechanisms and Materials. Chem. Rev., 114, 9919-9986; and Turchi, C. S. & Ollis, D. F. (1990). Photocatalytic degradation of organic water contaminants: mechanisms involving hydroxyl radical attack. Journal of catalysis, 122, 178-192, which is incorporated herein by reference in its entirety]. Upon the light absorption by TiO₂ photocatalyst (Eq. 3), electron/hole pairs are generated. The conduction band electrons (e_{cb}⁻) diffuse to the surface and react with the molecular oxygen, leading to oxygen anion radicals (O₂·⁻, Eq. 4). The latter can further react to form HO₂· and H₂O₂ species, as shown in Eqs. (5) and (6), respectively, whereas the valance band holes (h_{vb}⁺) can be trapped either at the bridging oxygen anions or react with the surface adsorbed water leading to the formation of >OH·_{br} or ·OH radicals, as shown in Eqs. 7 and 8, respectively [Schneider, J., Matsuoka, M., Takeuchi, M., Zhang, J., Horiuchi, Y., Anpo, M. & Bahnemann, D. W. (2014). Understanding TiO₂ Photocatalysis: Mechanisms and Materials. Chem. Rev., 114, 9919-9986, which is incorporated herein by reference in its entirety].

$${TiO}_{2} + UV ( A ) \to {h}_{VB}^{+} + {e}_{CB}^{-} \qquad ( 3 )$$

$${O}_{2} + {e}_{CB}^{-} \to {O}_{2}^{\cdot -} \qquad ( 4 )$$

$${O}_{2}^{\cdot -} + {H}^{+} \to {HO}_{2}^{\cdot } \qquad ( 5 )$$

$${HO}_{2}^{\cdot } + {e}_{CB}^{-} + {H}^{+} \to {H}_{2} {O}_{2} \qquad ( 6 )$$

$$> {OH}_{br}^{-} + {h}_{VB}^{+} \to > {OH}_{br}^{\cdot } + {H}^{+} \qquad ( 7 )$$

$${H}_{2} O + {h}_{VB}^{+} \to {OH}^{\cdot } + {H}^{+} \qquad ( 8 )$$

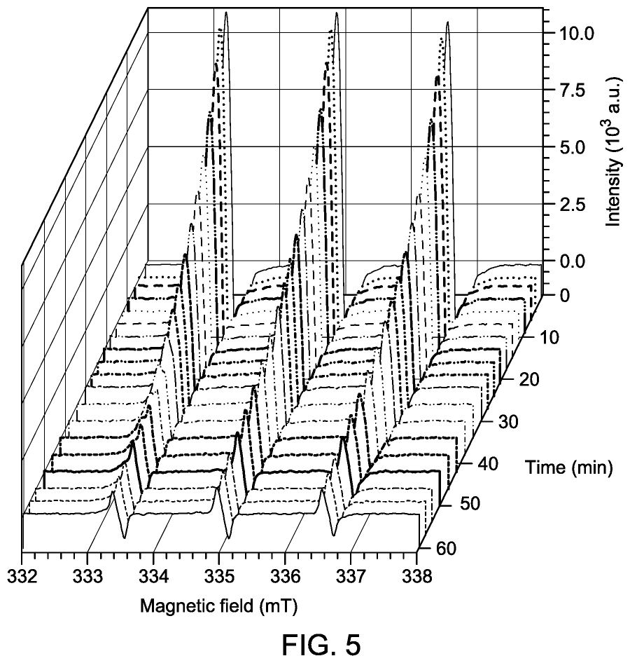

Distinguishing between the different types of ·OH radicals is usually not possible, and hereafter the ·OH radicals' term will be used to describe the ·OH radicals formed through the different pathways. The OH' radicals are likely the main species accountable for the photocatalytic oxidation of organic compounds. It is thus important to find a model compound for assessing the photocatalytic activity based on the detection of the OH′ radicals. It was observed that TEMPOL could react with the generated ROS species leading to the formation of an EPR silent compound. Using an EPR technique to directly measure the intensity without needing sample filtration added advantages of using TEMPOL. FIG. 5 shows the overlaid EPR signals of TEMPOL/TiO₂ suspension measured under UV(A) illumination. The TEMPOL concentration was 100 μM, and light intensity was 7 mW cm⁻². 60 EPR spectra are recorded at a time interval of 1.0 min, but few are shown for clarity.

### Influence of TEMPOL Concentration and TiO₂ Loading

According to the literature, TEMPOL reacts with the ·OH leading to EPR silent products [Dimitrijevic, N. M., Rozhkova, E. & Rajh, T. (2009). Dynamics of localized charges in dopamine-modified TiO₂ and their effect on forming reactive oxygen species. Journal of the American Chemical Society, 131, 2893-2899, which is incorporated herein by reference in its entirety].

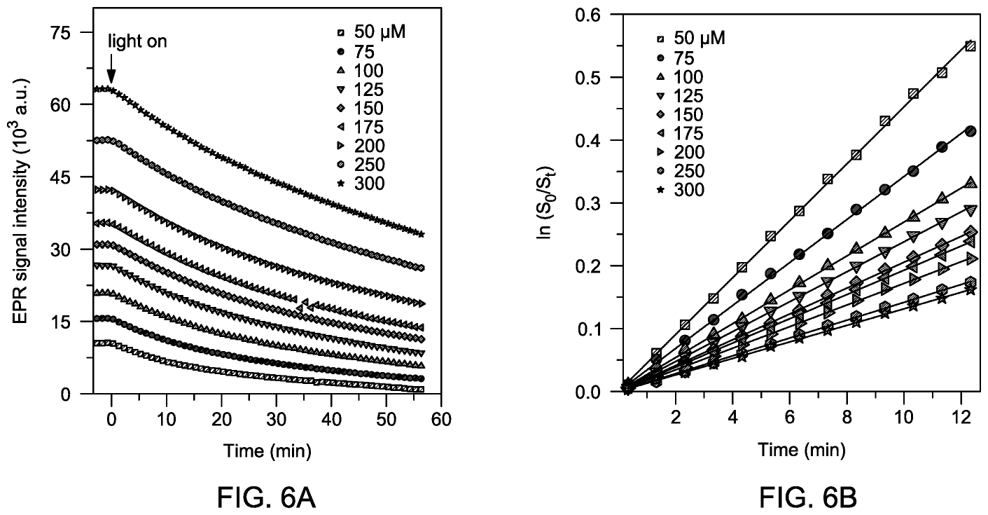

Consequently, the amount of the photo-catalytically generated ·OH can be correlated to the TEMPOL-deactivated products. FIG. 6A shows the profile of the photocatalytic deactivation of TEMPOL at different initial concentrations. FIG. 6B shows the plot of In(S₀/Sₜ) vs. time, where S₀ and Sₜ are the intensity of the EPR signal at t=0 and t min, respectively. Linear plots have been observed within the early stage of the reaction for all investigated concentrations of TEMPOL. The initial rate of the photocatalytic deactivation of TEMPOL has been measured assuming first-order kinetic. The initial rate (R₀) of photocatalytic deactivation of TEMPOL has been calculated using Eq. 9:

$${R}_{0} = {k}_{obs} [ {C}_{0} ] \qquad ( 9 )$$

where k_{obs} is the observed first-order rate constant derived from the slope of FIG. 6B, and C₀ is the initial concentration of TEMPOL in μM.

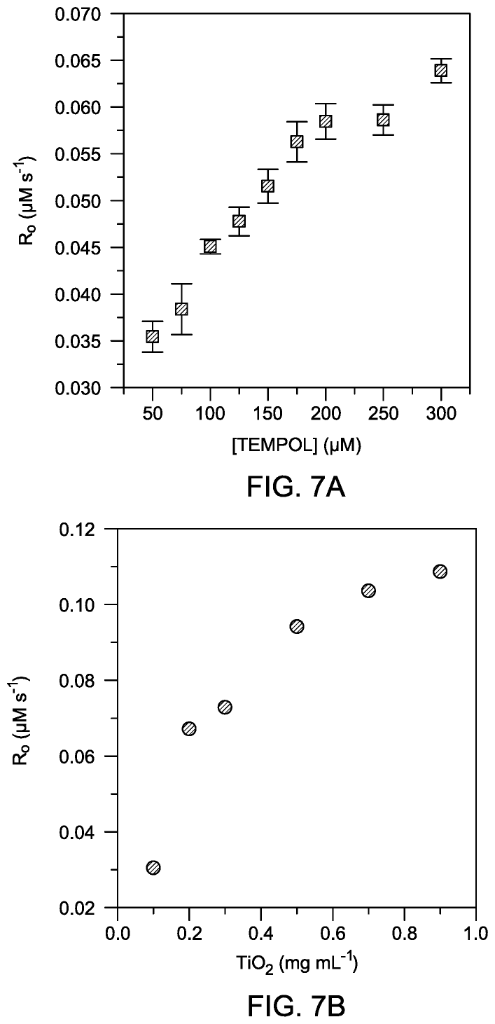

It was observed that the initial rate increases with increasing the initial concentration of the TEMPOL up to 200 μM, as shown in FIG. 7A. Then it levels off and reaches almost a saturation level. As proven by the dark adsorption measurement, the adsorption of TEMPOL on the surface of TiO₂—P25 is negligible. Thus, the rate of the photocatalytic deactivation of TEMPOL is limited by the diffusion of TEMPOL toward the surface of the photocatalyst and/or by the availability of the ·OH radicals on the surface. With the increase in the concentration of the TEMPOL, the flux of TEMPOL molecules diffusion towards the surface will increase, and thus the rate of the photocatalytic reaction increases. Beyond a specific limit (˜ 200 μM), the initial photocatalytic rate will be dominated by the availability of the surface ·OH radicals. Thus, the rate of TEMPOL deactivation starts to level off.

The influence of TiO₂—P25 loading on photocatalytic deactivation was also investigated and presented in FIG. 7B. The initial rate was found to increase with increasing the loading, and 0.5 g L⁻¹ was sufficient to reach the highest activity. The same trend has been previously reported for TiO₂—P25 with other model compounds [Wang, C.-y., Rabani, J., Bahnemann, D. W. & Dohrmann, J. K. (2002). Photonic efficiency and quantum yield of formaldehyde formation from methanol in the presence of various TiO₂ photocatalysts. Journal of Photochemistry and Photobiology A: Chemistry, 148, 169-176, which is incorporated herein by reference in its entirety].

### Example 6: Influence of Light Intensity

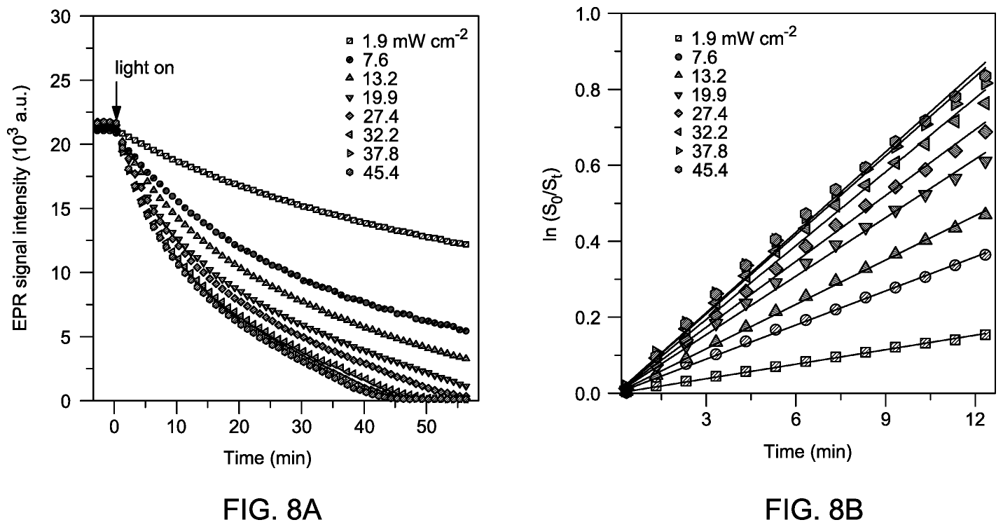

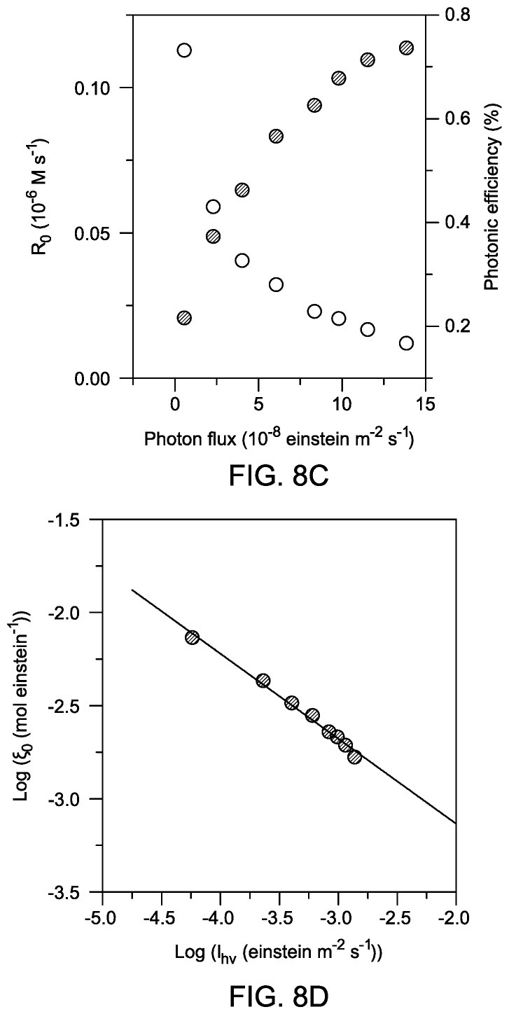

The influence of light intensity on the rate of photocatalytic reaction is a crucial parameter. FIG. 8A shows the profile of TEMPOL deactivation measured in the presence of TiO₂—P25 at different light intensities ranging from 1.8 to 46 mW cm⁻², more particularly about 1.9, 7.6, 13.2, 19.9, 27.4, 32.2, 37.8, and 45.4 mW cm⁻². The corresponding plot of In(S₀/Sₜ) versus time is presented in FIG. 8B. It is found that the initial rate of TEMPOL deactivation increases with increasing the light intensity due to the increase of photogenerated ·OH concentration by increasing the light intensity. At a very high light intensity, the rate starts to level off, which can be attributed to the saturation of the photocatalyst active sites with surface-bound ·OH radicals. Thus, any further increase in light intensity will lead to complete recombination for the photogenerated electron/hole pairs. It can also be attributed to the limited availability of TEMPOL at the surface of the photocatalyst.

FIG. 8C shows the relation between the initial rates of TEMPOL deactivation initial photonic efficiency (ξ₀) versus the photon flux. The initial photonic efficiency deactivation relation with the photon flux (Iₕᵥ) described by an empirical kinetic expression shown in Eq. 10 and by using its linearized form (Eq. 11), as shown in FIG. 8D, produced the slope value of (β-1) [Tschirch, J., Dillert, R. & Bahnemann, D. (2008). Photocatalytic degradation of methylene blue on fixed powder layers: Which limitations are to be considered? Journal of Advanced Oxidation Technologies, 11, 193-198, which is incorporated herein by reference in its entirety].

$${ξ}_{0} = {Vk}_{r} \frac{{KC}_{0}}{1 + {KC}_{0}} {η ( {I}_{hv} )}^{β - 1} \qquad ( 10 )$$

$$log ( {ξ}_{0} ) = log ( {Vk}_{r} \frac{{KC}_{0}}{1 + {KC}_{0}} η ) + ( β - 1 ) log ( {I}_{hv} ) \qquad ( 11 )$$

where kᵣ and K are kinetic parameters independent of the light intensity, C₀ is the initial concentration (mol L⁻¹), η is a dimensionless constant describing the efficiency of light absorption by the photocatalyst, and V is the volume of the test solution (L). The initial photonic efficiency (ξ₀) and photon flux (Iₕᵥ) are estimated according to Eqs. 12 and 13, respectively.

$${ξ}_{0} = \frac{{VR}_{0}}{{AI}_{hv}} \qquad ( 12 )$$

$${I}_{hv} = \frac{I λ}{{N}_{A} hc} \qquad ( 13 )$$

where A is the illuminated area, I is the incident light intensity, λ is the wavelength of the incident light, N_{A} is the Avogadro's number, h is the plank's constant, and c is the velocity of light. FIG. 8C shows a non-linear relation having a plateau at high photon flux, whereas the photonic efficiency shows a non-linear decrease with increasing photon flux. In FIG. 8D, the plot of log(ξ₀) versus the photon flux gives a straight line with a slope equal to (β-1), where β value was found to be 0.54. The β is an empirical constant related to the ratio between interfacial charge transfer and recombination of the charge carriers that depends on the photocatalytic materials. The obtained β is comparable to the reported value (0.5) of many photocatalytic systems as concluded from the linear dependence between the square root of the absorbed light intensity and the photonic efficiency of TiO₂-aqueous suspension [Goldstein, S., Behar, D. & Rabani, J. (2009). Nature of the oxidizing species formed upon UV photolysis of C—TiO₂ aqueous suspensions. The Journal of Physical Chemistry C, 113, 12489-12494; and Wang, C.-y., Rabani, J., Bahnemann, D. W. & Dohrmann, J. K. (2002). Photonic efficiency and quantum yield of formaldehyde formation from methanol in the presence of various TiO₂ photocatalysts. Journal of Photochemistry and Photobiology A: Chemistry, 148, 169-176, which is incorporated herein by reference in its entirety].

### Mechanisms of the Photocatalytic Deactivation of TEMPOL

It is more likely that the deactivation of TEMPOL occurs through the oxidation by the photogenerated ·OH radicals [Dimitrijevic, N. M., Rozhkova, E. & Rajh, T. (2009). Dynamics of localized charges in dopamine-modified TiO₂ and their effect on the formation of reactive oxygen species. Journal of the American Chemical Society, 131, 2893-2899]. Generally, in photocatalysis, molecular oxygen is used as an electron acceptor that reacts very fast with the photogenerated electrons (within 100 ns to 100 μs), leading to the formation of O₂·⁻ [Schneider, J., Matsuoka, M., Takeuchi, M., Zhang, J., Horiuchi, Y., Anpo, M. & Bahnemann, D. W. (2014). Understanding TiO₂ Photocatalysis: Mechanisms and Materials. Chem. Rev., 114, 9919-9986]. The produced oxygen radical molecule might further react to form ·OH radicals; however, the primary ·OH radicals are produced via the valance band holes. To identify the non-radical final products resulting from the photocatalytic deactivation of TEMPOL, sets of photocatalytic tests have been performed in the presence of oxygen as an electron acceptor, in the absence of oxygen (continuously purging with nitrogen gas) and in the presence of methanol to trap the ·OH radicals.

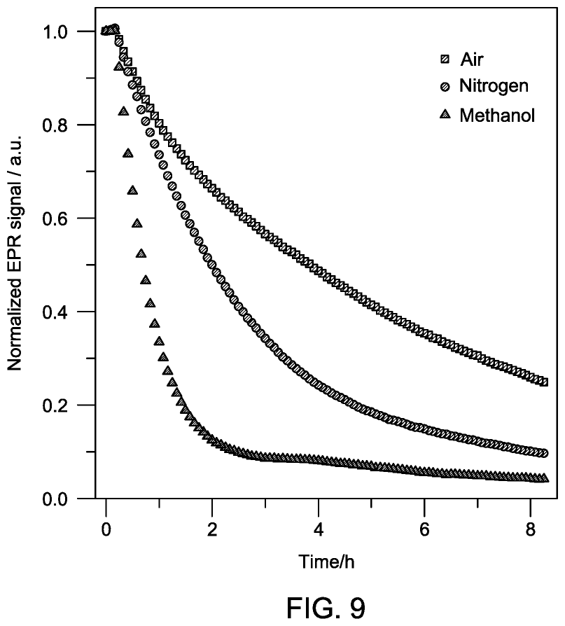

FIG. 9 shows the time course of these EPR-photocatalytic tests at 1000 μM TEMPOL over 8 hours. It is apparent from FIG. 9 that the presence or the absence of the electron acceptor (molecular oxygen) does not significantly change the initial rate of TEMPOL deactivation, especially during the first hour of the process. Only about 20% and 25% of TEMPOL are deactivated in the presence and absence of oxygen, respectively. The analysis of the reaction mixture and the final non-radical products indicated that oxidized forms of TEMPOL, namely TEMPONE (4-oxo-2,2,6,6-tetramethylpiperidine-1-oxyl, radical) and 4-oxo-2,2,6,6-tetramethylpiperidine (non-radical), are formed. The ratio of radicals present at the end of the test is achieved by simulating the EPR spectra of the reaction mixture with the help of WinSim-EPR software available from the National Institute of Environmental Health Sciences (NIEHS) [Duling, D. R. (1994). Simulation of multiple isotropic spin-trap EPR spectra. Journal of Magnetic Resonance, Series B, 104, 105-110]. The simulated EPR spectrum using the hyperfine values and peak-to-peak widths of 48% and 52% of TEMPOL and TEMPONE, respectively, reproduces the observed experimental peaks of the mixture. On the other hand, the ¹H-NMR and ¹³C-NMR analysis of the extracted product of the reaction mixture confirmed the production of 4-oxo-2,2,6,6-tetramethylpiperidine form, as shown in FIGS. 10A-10C.

The TEMPOL photocatalytic deactivation products detected in the absence and presence of oxygen are in good agreement with the recently published work by D. L. Marshall et al. [Marshall, D. L., Christian, M. L., Gryn'ova, G., Coote, M. L., Barker, P. J. & Blanksby, S. J. (2011). Oxidation of 4-substituted TEMPO derivatives reveals modifications at the 1- and 4-positions. Organic & biomolecular chemistry, 9, 4936-4947]. Based on the NMR results and the computed models, the possible mechanism of photocatalytic deactivation of TEMPOL is described. In this mechanism, the photogenerated OH· radicals firstly convert TEMPOL to TEMPONE through α-proton abstraction at the 4-piperidine position. Further, the deactivation process at the nitroxide group of TEMPONE is continued to produce the non-radical product 4-oxo-tetramethylpiperidine (FIG. 11).

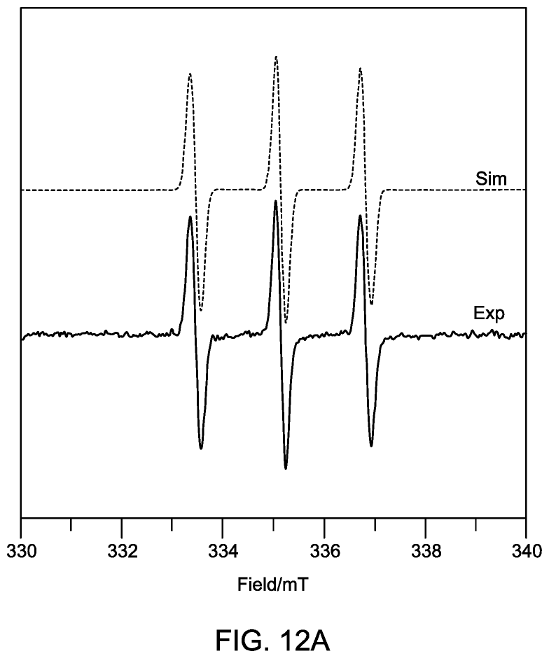

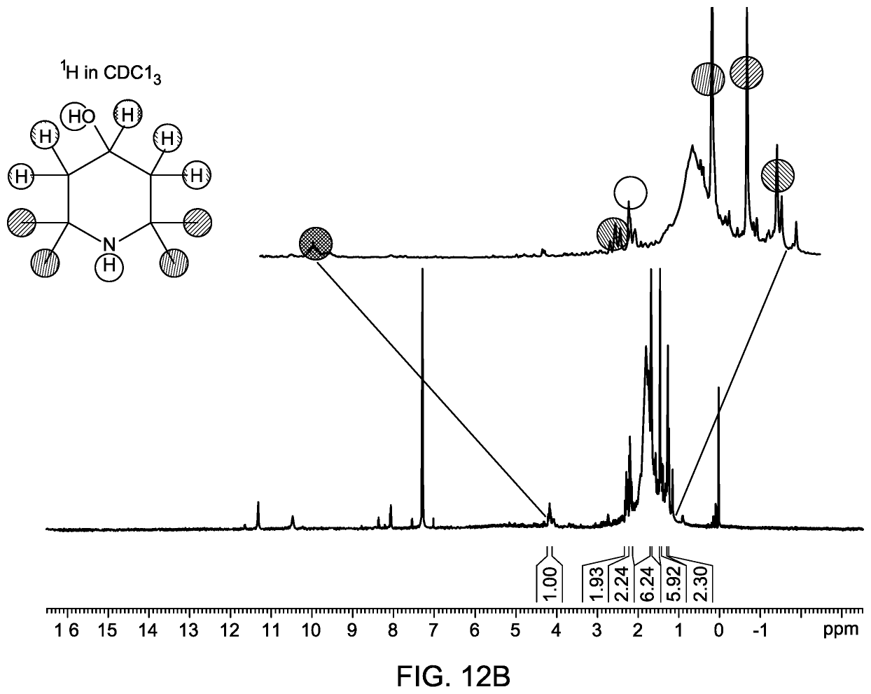

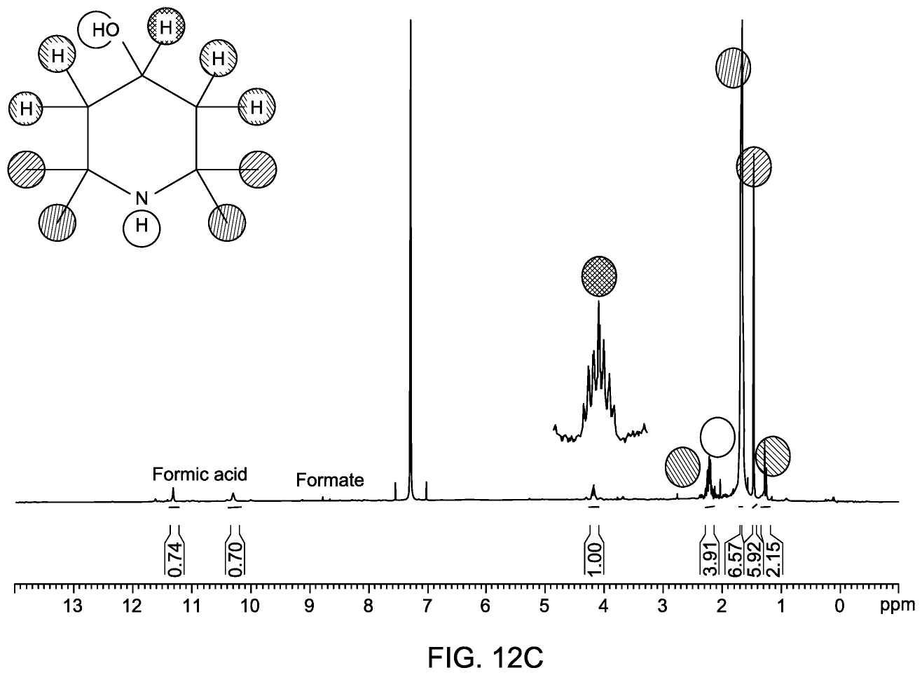

In the presence of methanol, the initial rate of TEMPOL deactivation increased by four times compared to that observed in the absence of methanol. The observed enhancement of TEMPOL deactivation could be correlated with the known ability of methanol to react with the photogenerated holes within less than 10 ns and/or ·OH radicals to form α-hydroxyl radicals (·CH₂OH) [Nosaka, Y. & Nosaka, A. Y. (2017). Generation and Detection of Reactive Oxygen Species in Photocatalysis. Chem. Rev., 117, 11302-11336; Tang, J., Durrant, J. R. & Klug, D. R. (2008). Mechanism of photocatalytic water splitting in TiO₂. Reaction of water with photoholes, importance of charge carrier dynamics, and evidence for four-hole chemistry. Journal of the American Chemical Society, 130, 13885-13891; Horváth, E., Rossi, L., Mercier, C., Lehmann, C., Sienkiewicz, A. & Forró, L. (2020). Photocatalytic nanowires-based air filter: Towards reusable protective masks. Advanced functional materials, 30, 2004615; and Marugán, J., Hufschmidt, D., López-Muñoz, M.-J., Selzer, V. & Bahnemann, D. (2006). Photonic efficiency for methanol photooxidation and hydroxyl radical generation on silica-supported TiO₂ photocatalysts. Applied catalysis B: environmental, 62, 201-207]. The NMR analysis of the deactivation products of TEMPOL indicates that the main product is a non-radical compound, namely, 4-hydroxyl-tetramethypiperidine (FIG. 12). A trace of TEMPONE has been detected by the EPR analysis of the leftover TEMPOL radicals (FIG. 12A).

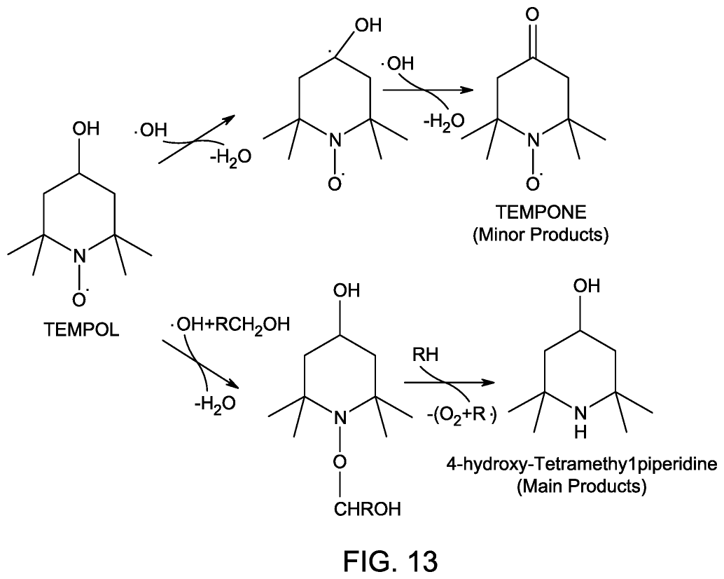

Based on the photocatalytic results, product analysis, and the described computational models, the mechanism of TEMPOL deactivation in the presence of methanol is presented in FIG. 13. It consists of two parallel pathways, a minor one to form TEMPONE initiated by direct-attach of ·OH radicals at the α-hydrogen in the 4-piperidine position. While the major path starts with the α-hydroxyl radicals (′CH₂OH) attack at the nitroxide side of TEMPOL to produce the non-radical product (4-hydroxy-tetramethylpiperidine) and the oxidation form of methanol.

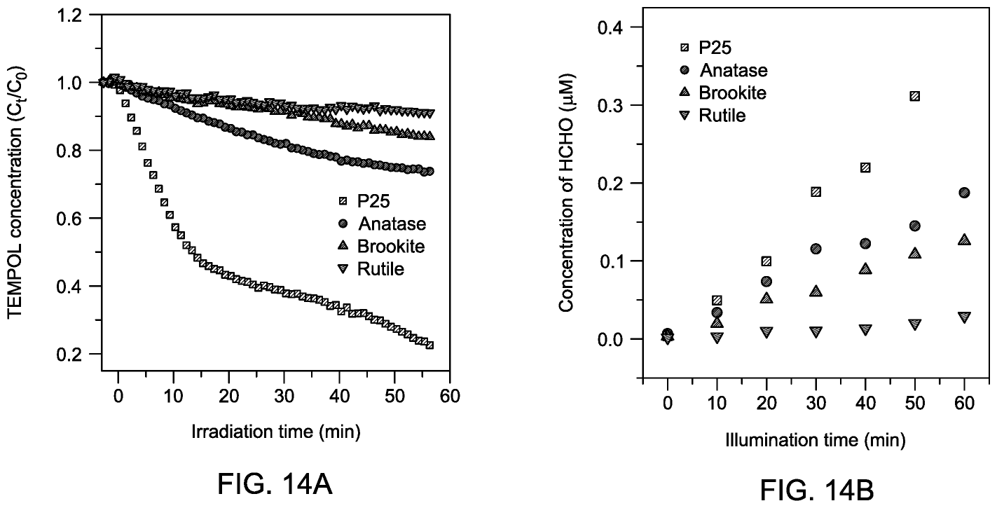

To test the potential application of TEMPOL to monitor the photocatalytic activity of different photocatalysts, different crystalline forms of TiO₂ have been prepared and characterized according to Ref. [Kandiel, T. A., Feldhoff, A., Robben, L., Dillert, R. & Bahnemann, D. W. (2010). Tailored Titanium Dioxide Nanomaterials: Anatase Nanoparticles and Brookite Nanorods as Highly Active Photocatalysts. Chem. Mater., 22, 2050-2060]. FIG. 14A shows the time course of TEMPOL deactivation over rutile, anatase, and brookite TiO₂ photocatalysts compared to TiO₂ P25. The photocatalytic activities of the same photocatalysts have been assessed by following the rate of photocatalytic methanol oxidation by measuring spectrophotometrically the main oxidation product, i.e., formaldehyde [Kandiel, T. A., Robben, L., Alkaim, A. & Bahnemann, D. (2013). Brookite versus anatase TiO₂ photocatalysts: phase transformations and photocatalytic activities. Photochem. Photobiol. Sci., 12, 602-609] (FIG. 14B). By comparing the two methods, it can be seen that TiO₂ P25 has the highest activity and TiO₂ rutile has the lowest activity. It can also be seen that TiO₂ anatase has better activity than brookite and rutile. The difference in the photocatalytic activities of the investigated photocatalysts towards the methanol oxidation is more evident than that of the TEMPOL deactivation. This can be attributed to two reasons: (1) the initial methanol concentration is 2500-fold higher than that of TEMPOL, and (2) methanol can react with ·OH radicals and directly with the photogenerated holes [Ahmed, A. Y., Kandiel, T. A., Ivanova, I. & Bahnemann, D. (2014). Photocatalytic and photoelectrochemical oxidation mechanisms of methanol on TiO₂ in aqueous solution. Appl. Surf. Sci., 319, 44-49], but TEMPOL reacts more likely with ·OH radicals only.

The results indicate that following the TEMPOL deactivation reaction by using EPR can be used to fast evaluate the photocatalytic activity of photocatalyst suspensions without the need for filtration or the wait for a long time to establish adsorption equilibrium. TiO₂ P25 can be used as a standard photocatalyst, and the initial rate of the investigated photocatalysts can be reported relative to that of TiO₂ P25 for ease of comparing the results produced at different labs. TEMPOL radicals have been tested as a model compound to directly monitor the photocatalytic activity of TiO₂ suspension using EPR. It exhibits outstanding stability in aqueous solution in the dark and under UV(A) illumination. TEMPOL does not absorb UV(A) and visible light; thus, the photosensitization problem associated with the dyes (e.g., MB) and phenolic compounds can be readily overcome. The dark adsorption results indicated that the adsorption of TEMPOL on TiO₂ is negligible. Unlike MB, the TEMPOL can be directly used without spending a long-time establishing adsorption equilibrium before the photocatalytic test. The influence of TEMPOL concentration, TiO₂ loadings, and light intensity on the rate of photocatalytic deactivation of TEMPOL have been investigated and analyzed. The initial rate of the photocatalytic deactivation reaction was found to be sensitive to the concentration of TEMPOL, light intensity, and TiO₂ loading.

It is also concluded that the rate is limited by the diffusion of TEMPOL to the surface of TiO₂ and by the availability of ·OH radicals. The analysis of the photocatalytic deactivation products formed in the presence and absence of oxygen indicated that TEMPOL is mainly oxidized by the ·OH radicals via the abstraction of the α-hydrogen at the 4-piperidine position, and two main products are formed (i.e., TEMPONE (4-oxo-2,2,6,6-tetramethylpiperidine-1-oxyl, radical and 4-oxo-2,2,6,6-tetramethylpiperidine). In the presence of methanol as ·OH radicals' scavenger, it reacts with the photogenerated OH′ radicals leading to the formation of ·CH₂OH radicals. The latter radicals deactivate TEMPOL by the attack at the nitroxide side of TEMPOL, leading to the formation of a mainly non-radical compound, namely, 4-hydroxyl-tetramethylpiperidine. By comparing the photocatalytic deactivation of TEMPOL over different TiO₂ photocatalysts with the photocatalytic oxidation of methanol, the same trends have been observed, evincing that the system has a great potential for application as a standard method for assessing the photocatalytic activity of particulate photocatalyst suspensions without the need for filtration or the wait for a long time to establish adsorption equilibrium.

Numerous modifications and variations of the present disclosure are possible in light of the above teachings. It is therefore to be understood that within the scope of the appended claims, the invention may be practiced otherwise than as specifically described herein.

1: A method for monitoring and evaluating the photocatalytic activity of a photocatalytic substance, comprising:
mixing and dissolving 4-hydroxy-2,2,6,6-tetramethylpiperidine-N-oxyl (TEMPOL) in a liquid to form a TEMPOL solution;
dispersing particles of the photocatalytic substance in the TEMPOL solution to form a photocatalytic suspension;
purging the photocatalytic suspension by introducing a gas composition to a reactor containing the photocatalytic suspension under continuous agitation in the dark to form a purged photocatalytic suspension;
illuminating the purged photocatalytic suspension in the reactor with a light to initiate a photocatalytic reaction and generate a reactive oxygen species (ROS) that is detectable by an electron paramagnetic resonance (EPR) spectrometer;
wherein the EPR spectrometer comprises an EPR cell having a sample inlet and a sample outlet, a cavity for holding the EPR cell, at least two magnet components that are adjacent to the cavity to generate a magnetic field around the cavity, and a pump for conveying the purged photocatalytic suspension to the EPR cell;
introducing a portion of the purged photocatalytic suspension via the sample inlet to the EPR cell in the cavity of the EPR spectrometer to generate an EPR signal by detecting the reactive oxygen species and recirculating the portion of the purged photocatalytic suspension back to the reactor via the sample outlet after passing through the EPR cell;
reacting TEMPOL with the reactive oxygen species to form a EPR silent compound thereby reducing the intensity of the EPR signal generated by the reactive oxygen species; and
continuously recording the EPR signal;
wherein the EPR signal is numerically digitally displayed and visually displayed to monitor and evaluate the photocatalytic activity of the photocatalytic substance suspended in the liquid.

2: The method of claim 1, wherein the photocatalytic substance is at least one selected from the group consisting of zinc oxide, tin oxide, iron oxide, dibismuth trioxide, tungsten trioxide, strontium titanate, titanium dioxide, and a mixture thereof.

3: The method of claim 1, wherein the photocatalytic substance is titanium dioxide, and wherein the titanium dioxide comprises at least one selected from the group consisting of a flame pyrolysis-treated titanium dioxide, a nitrogen-doped titanium dioxide, and a plasma-treated titanium dioxide.

4: The method of claim 3, wherein the titanium dioxide is at least one selected from the group consisting of rutile-type titanium dioxide, anatase-type titanium dioxide, brookite-type titanium dioxide, titanium dioxide P25, and a mixture thereof.

5: The method of claim 1, wherein the photocatalytic substance has an average particle size of 0.2 to 1 μm.

6: The method of claim 1, wherein the photocatalytic substance is present in the photocatalytic suspension at a concentration of 0.05 to 5 milligrams per milliliter (mg/ml) based on a total volume of the TEMPOL solution.

7: The method of claim 1, wherein the photonic efficiency of the photocatalytic suspension has a linear dependence on the square root of an intensity the light during the illuminating.

8: The method of claim 1, wherein the TEMPOL solution has a concentration of 10 to 1000 μM.

9: The method of claim 8, wherein the TEMPOL solution has a concentration of 200 to 300 μM.

10: The method of claim 1, wherein the TEMPOL does not absorb the light, and wherein the photocatalytic substance does not absorb the TEMPOL under dark conditions.

11: The method of claim 1, wherein the TEMPOL has at least one peak in the range of 320 to 350 magnetic field (mT) on an EPR spectrum with a g-value of 1.97 to 2.03.

12: The method of claim 1, wherein the light comprises UV light and visible light, and wherein the light has an intensity in a range of 0.5 to 80 milliwatts per square centimeter (mW cm⁻²).

13: The method of claim 1, wherein the gas composition comprises at least one gas selected from the group consisting of air, nitrogen, and oxygen.

14: The method of claim 1, wherein the EPR signal is collected at a modulation frequency of 50 to 200 kilohertz (kHz) by the EPR spectrometer.

15: The method of claim 1, wherein the EPR is collected at a sweep time of 5 to 20 seconds (s) and a width of 5 to 20 mT by the EPR spectrometer.

16: The method of claim 1, wherein the EPR is collected at an amplitude attenuation of 1 to 5 milliwatts (mW), and an amplitude modulation of 50 to 400 microteslas (μT) by the EPR spectrometer.

17: The method of claim 1, wherein the reactive oxygen species present in the photocatalytic suspension is in the form of at least one selected from the group consisting of hydroxyl radical (·OH), superoxide anion radical (·O₂⁻), singlet oxygen (¹O₂), and hydrogen peroxide (H₂O₂).

18: The method of claim 1, wherein the EPR silent compound is at least one selected from the group consisting of 4-oxo-2,2,6,6-tetramethylpiperidine-1-oxyl radical (TEMPONE), 4-oxo-2,2,6,6-tetramethylpiperidine, and 4-hydroxyl-tetramethypiperidine, and wherein the EPR silent compound results in a decay of the EPR signal.

19: The method of claim 1, wherein filtration is not required to separate the photocatalytic substance from the photocatalytic suspension before analysis compared to methods involving photosensitive compounds that requires filtration before analysis, and wherein the photosensitive compounds that requires filtration before analysis comprises methylene blue bleaching and a phenolic compound.

20: The method of claim 1, having a EPR signal intensity of 5×10³ to 75×10³ astronomical (a.u.) at a light intensity of 0.5 to 80 mW cm⁻².
